(19) United States
(12) Patent Application Publication
(10) Pub. No.: US 2026/0148091 A1
(43) Pub. Date: May 28, 2026

(54) FEDERATED LEARNING BASED ON SILOED DATA HOSTED ON DATA PROCESSING SYSTEMS

(71) Applicant: Dell Products L.P., Round Rock, TX (US)

(72) Inventors: ANDREA ROGGERONE, Dublin (IE); VINAY SAWAL, Fremont, CA (US); MUZHAR S. KHOKHAR, Shrewsbury, MA (US); BRIAN ROCHFORD, Cork (IE); RAJINI RAMACHANDRAN KARTHIK, Austin, TX (US)

(21) Appl. No.: 18/962,789

(22) Filed: Nov. 27, 2024

(51) Int. Cl. G06N 3/098

(52) U.S. Cl. CPC G06N 3/098

(57) ABSTRACT

Methods and systems for managing operation of data processing systems that each host siloed data that is restricted from movement between the data processing systems are disclosed. Local model instances of an inference model may be established for each data processing system based on a set of global model weights. The local model instances may be locally trained using the respective local model instance and respective siloed data to obtain a set of model weights. The set of model weights and weightage information may be used to update the set of global model weights (e.g., via weighted aggregation). The weightage information may indicate a quality of inferences, a quantity of training data, and/or any other information. The local model instances may be updated using the global model weights to provide computer-implemented services using the siloed data.

### FIELD

Embodiments disclosed herein relate generally to managing operation of data processing systems that each host siloed data that is restricted from movement. More particularly, embodiments disclosed herein relate to updating the operation of the data processing systems based on local model instances and the siloed data.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams in accordance with an embodiment.

FIGS. 3A-3C show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems. While operating, the data processing systems may collect data relevant to the operation of the data processing systems. The data may be siloed and restricted from movement between the data processing systems (e.g., due to administrative regulation, confidentiality, computational resource limitations, etc.).

The operation of each of the data processing systems may be updated using a local model instance hosted by a respective data processing system and based on the siloed data hosted by the respective data processing system. The local model instance may be obtained based on a global model managed by a management system. The management system may select an inference model architecture and distribute the model architecture to the data processing systems to facilitate obtaining of the local model instances through local training by each of the data processing system and based on the siloed data.

By doing so, the management system may obtain, from each of the data processing systems, a set of model weights and weightage information for the respective data processing system. The weightage information may indicate, for example, a quality of inferences with respect to computer-implemented services provided by the respective data processing system, accuracy of inferences, a proportion of training data hosted by the respective data processing system, and/or any other information.

Using the set of weights and the weightage information, the management system may obtain a set of global model weights and provide the set of global model weights to the data processing systems for use in updating operation of the local model instances hosted by the data processing systems. Additionally, the data processing systems may iteratively retrain the local model instances as new training data becomes available to the respective data processing systems and provide updated sets of weights to the management system for updating the global model.

Thus, embodiments disclosed herein may provide an improved method for managing operation of data processing systems that each host siloed data by using local model instances hosted by each respective data processing system. The local model instances may be based on a global model managed by a management system and based on sets of model weights and weightage information from each data processing system of the data processing systems. By doing so, a quality of computer-implemented services provided by the data processing systems may be improved.

In an embodiment, a method for managing operation of data processing systems that each host siloed data that is restricted from movement between the data processing systems is provided. The method may include: (i) obtaining, from each of the data processing systems:
(a) a set of model weights from a local model instance of an inference model that is hosted by a respective data processing system and that was trained using at least a portion of the respective siloed data hosted by the respective data processing system, (b) weightage information for the respective data processing system; (ii) obtaining a set of global model weights using the sets of model weights and weightage information; and (iii) updating operation of the local model instances hosted by the data processing systems using the set of global model weights to initiate provisioning of computer-implemented services by the data processing systems using the updated local model instances.

The weightage information may indicate indicates a quality of inferences provided by the local model instance with respect to a portion of the computer-implemented services provided by the respective data processing system.

The quality may be based on a quantification function with respect to the computer-implemented services, the quantification function providing a quantification regarding desirability of the portion of the computer-implemented services.

The desirability of the portion of the computer-implemented services may be based on a level of adherence of the portion of the computer-implemented services to a service level agreement for the portion of the computer-implemented services.

The weightage information may indicate an accuracy of inferences provided by the local model instance.

The weightage information may be based on a proportion of training data hosted by the respective data processing system to a total quantity of training data available to train all of the local model instances hosted by all of the data processing systems.

The weightage information may be based on a level of anomalousness of a proportion of training data hosted by the respective data processing system with respect to all training data available to train all of the local model instances hosted by all of the data processing systems.

The method may also include: prior to obtaining the set of model weights: (i) selecting a model architecture; and (ii) distributing the model architecture to the data processing systems to facilitate obtaining of the local model instances through local training by each of the data processing systems.

The method may also include: after updating operation of the local model instances: (i) iteratively retraining the updated local model instances by the respective data processing systems that host the updated local model instances as new training data becomes available to the respective data processing systems; and (ii) updating the set of weights during the iterative retraining based on new sets of model weights obtained by the respective data processing systems.

The siloed data may include at least one selected from a list of types of information consisting of: (i) first information subject to administrative regulation that restricts movement of the first information between the data processing systems; (ii) second information subject to confidentiality that restricts movement of the second information between the data processing systems; and (iii) third information subject to computational resource limitations that restricts movement of the third information between the data processing systems.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

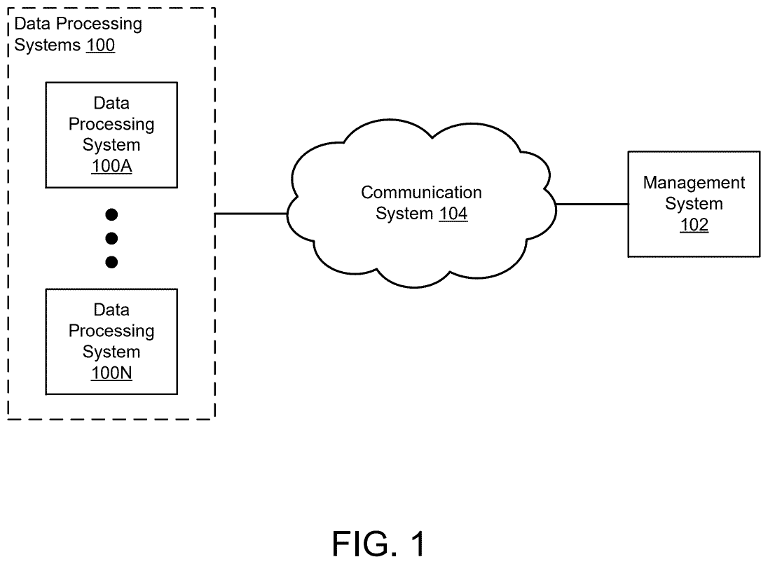

Turning to FIG. 1, a block diagram illustrating a system in accordance with an embodiment is shown. The system shown in FIG. 1 may provide any type and quantity of computer-implemented services (e.g., to user of the system and/or devices operably connected to the system).

The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1). Other types of computer-implemented services may be provided by the system shown in FIG. 1 without departing from embodiments disclosed herein.

While providing the computer-implemented services, the data processing systems may collect data relevant to the operation of the data processing systems (e.g., performance data, health data, application data, telemetry data, etc.). The data processing systems may use the data to obtain information usable to provide desired computer-implemented services. For example, the data may be used to derive insights, obtain inferences, inform management decisions, and/or any other perform actions.

To do so, the data processing systems may transmit at least a portion of the data to a management system (e.g., a data processing system tasked with managing operation of the data processing systems). The management system may subsequently analyze the data and provide at least a portion of the desired computer-implemented services based on the data.

However, because the data hosted on each data processing system may be restricted from movement, a quality of computer-implemented services provided by the data processing systems based on the siloed data may be negatively impacted. For example, the data processing systems may be subject to administrative regulation (e.g., data sovereignty rules) that restricts movement of the data generated by a data processing system of the data processing systems, confidentiality issues that restrict sharing of the data (e.g., to other data processing systems), computational resource limitations (e.g., a volume of data that may not be processed in a timely manner), and/or any other limitations that restrict movement of the data.

In general, embodiments disclosed herein may provide methods, systems, and/or devices for managing data processing systems that each host siloed data that is restricted from movement between the data processing systems. To improve a quality of computer-implemented services provided by the data processing systems based on the siloed data, the data processing systems may each use a local instance of an inference model to initiate provisioning of the computer-implemented services based on siloed data hosted by a respective data processing system.

To obtain a local model instance, a management system may obtain a global model (e.g., a central inference model managed by the management system and shared with each data processing system) by selecting a model architecture (e.g., a machine learning framework, a neural network configuration, foundation model, etc.) and distributing the model architecture to the data processing systems. Once obtained, the data processing systems may each locally train a respective local model instance based on training data (e.g., a portion of the siloed data) hosted by the respective data processing system. Additionally, each data processing system may evaluate a quality of the respective local model instance (e.g., accuracy of inferences, quality of inferences with respect to computer-implemented services, etc.).

By doing so, each data processing system may obtain a set of weights corresponding to the local model instance and weightage information for the respective data processing system. The weightage information may, for example, include the quality of the respective local model instance, indicate a level of anomalousness of a proportion of training data used to train the local model instance, indicate a proportion of training data hosted by the respective data processing system to a total quantity of training data available to train all of the local model instances hosted by all of the data processing systems, and/or provide any other information.

Once obtained, the sets of weights and weightage information may be provided to the management system by the data processing systems. To do so, each data processing system may communicate with the management via a secure communication channel. Therefore, the management system may obtain information that reflects a usefulness of each local model instance based on the respectively hosted siloed data without movement of the siloed data from the respective data processing system.

The management system may subsequently perform a weighted aggregation process to update the global model. For example, the management system may multiply each set of weights by the corresponding weighted information for the respective data processing system to obtain results and add the results to obtain a weighted average. By doing so, the management system may obtain an updated set of global model weights that may provide a generalized model based on contributions by each local model instance.

The updated set of global model weights may be distributed to each data processing system to update operation of the local model instances and initiate provisioning of computer-implemented services by the data processing systems using the updated local model instances. For example, each data processing system of the data processing systems may collect new data, obtain an inference using the updated local model instance and based on the new data, update operation of a respective data processing system based on the inference, and/or perform any other processes. Additionally, each data processing system may iteratively retrain the updated local model instance using the new data and provide an updated set of weights to the management system for use in updating the global model.

Thus, the local model instances used by the data processing systems may be improved for use in obtaining relevant information based on siloed data hosted by each data processing system.

To provide the above noted functionality, the system may include data processing systems 100, and management system 102. Each of these components is discussed below.

Data processing systems 100 may include any number of data processing systems (e.g., 100A-100N) that may provide at least a portion of the computer-implemented services (e.g., to users of data processing system 100). To do so, data processing systems 100 may collect data relevant to operation of data processing systems and store the data on each respective data processing system. Data processing systems 100 may host a local model instance of an inference model to obtain inferences based on the stored data and desired computer-implemented services based on the inferences. Because the stored data may be siloed (e.g., restricted from movement from each respective data processing system), each data processing system may: (i) train the local model instance using at least a portion of the siloed data to obtain an updated set of weights, (ii) generate weightage information relevant to the respective data processing system, (iii) communicate the updated set of weights and the weightage information to management system 102, and/or perform any other actions.

As discussed above, management system 102 may provide management services (e.g., for data processing systems 100). To provide the management services, management system 102 may (i) distribute a selected model architecture to data processing systems 100, (ii) obtain updated sets of weights and weightage information from data processing systems 100, (iii) perform a weighted aggregation process based on the sets of weights and weightage information to obtain a set of updated global model weights, (iv) update operation of local model instances hosted by data processing systems 100 using the set of updated global model weights, and/or perform any other actions.

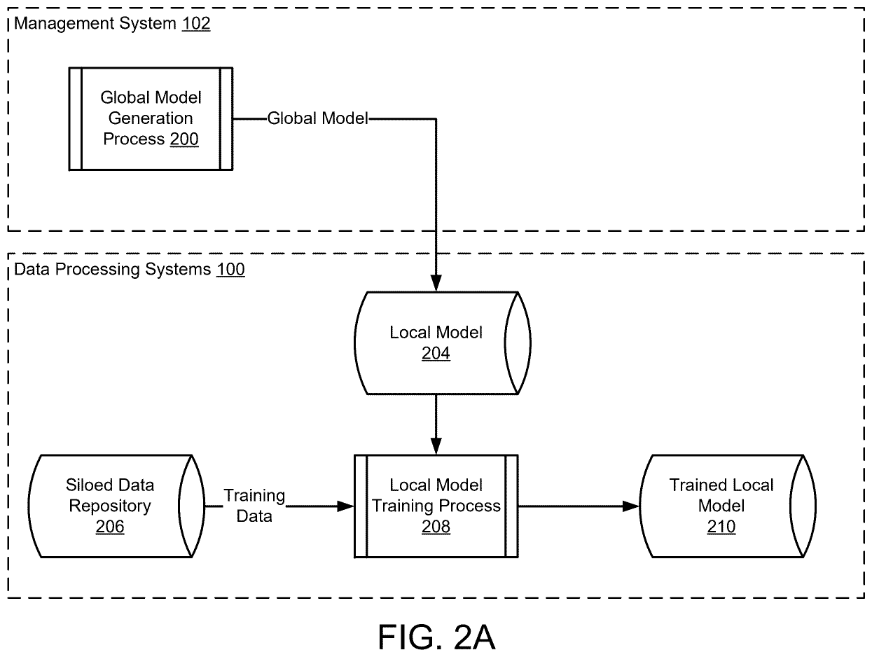

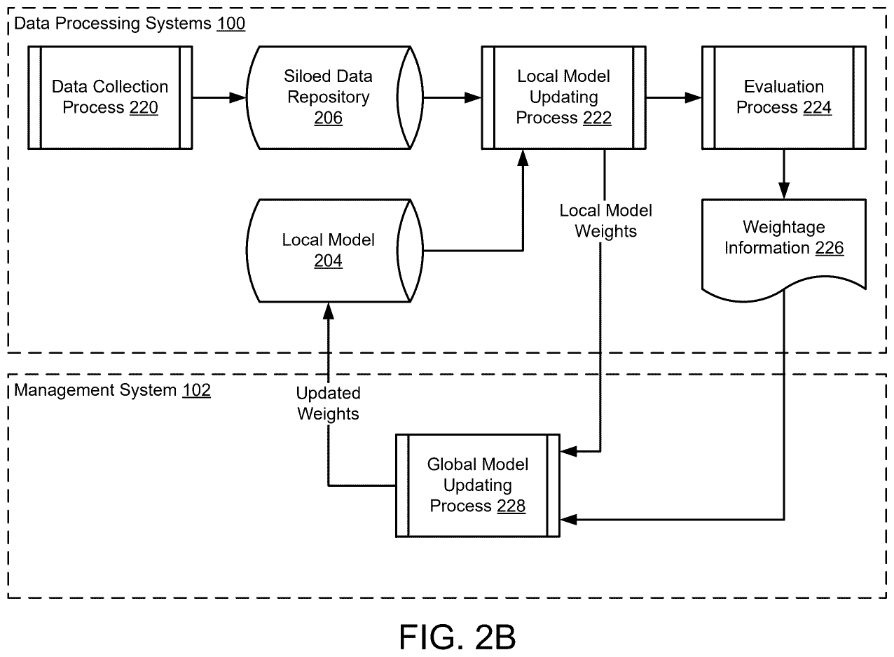

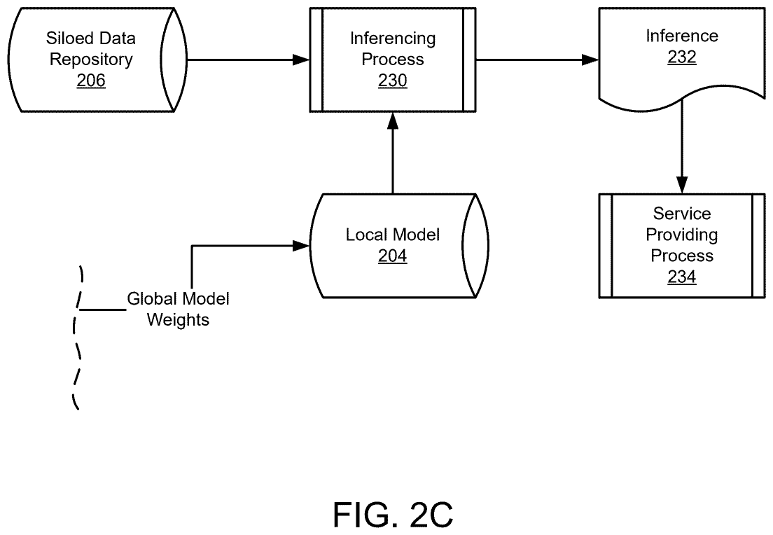

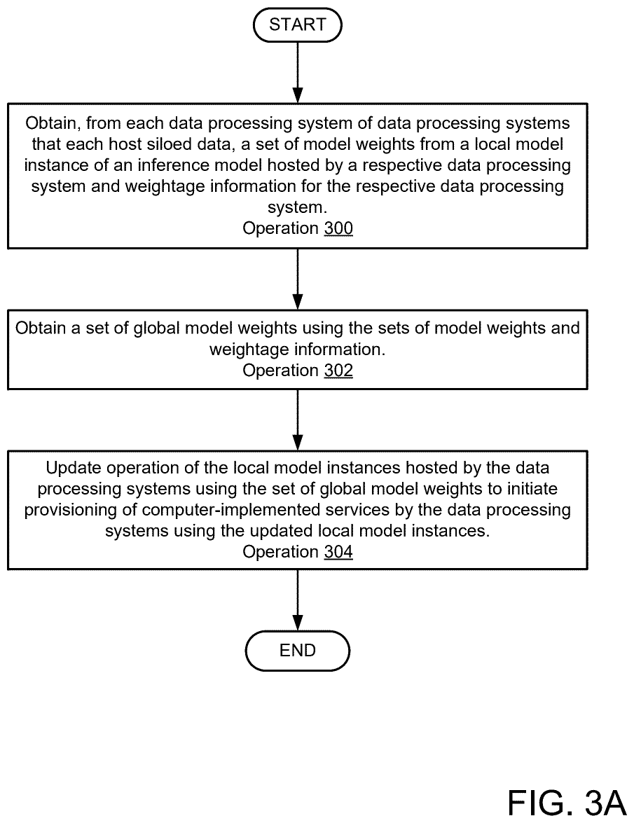

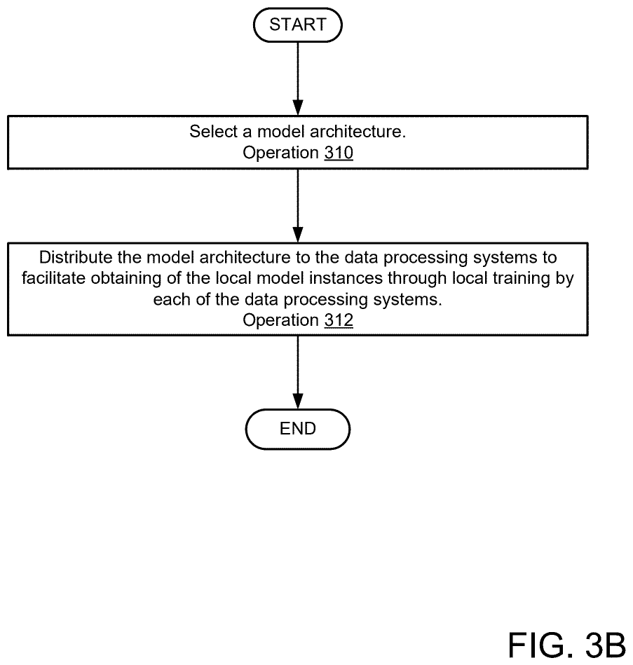

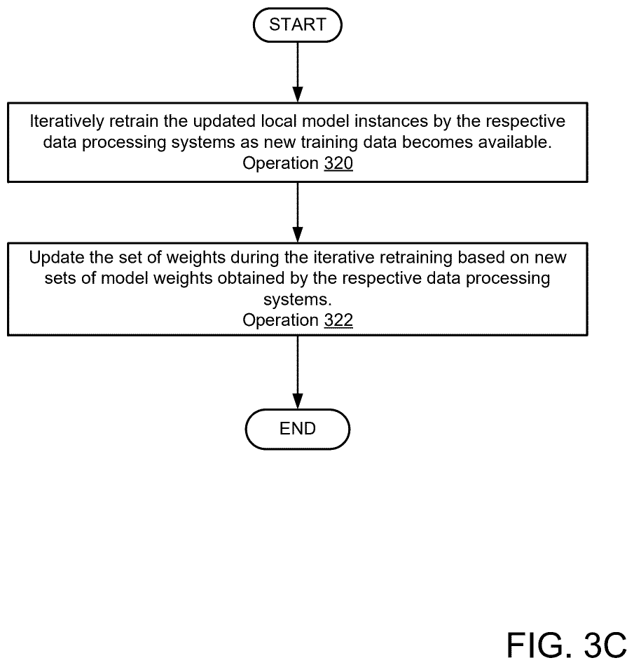

While providing their functionality, any of data processing systems 100 and/or management system 102 may provide all or a portion of the methods shown in FIGS. 2A-3C.

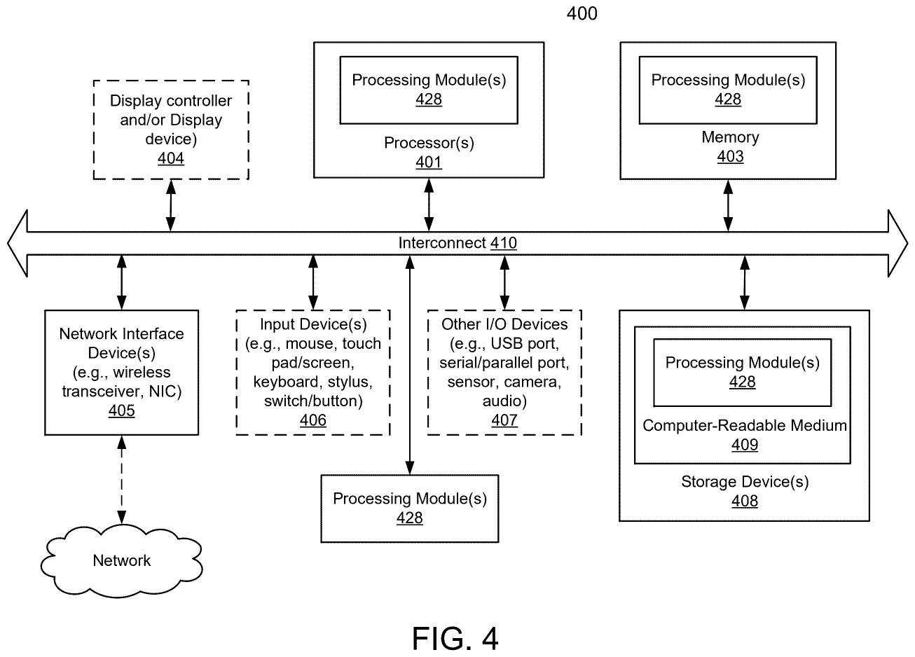

Communication system 104 may allow any of data processing systems 100, and management system 102 to communicate with one another (and/or with other devices not illustrated in FIG. 1). To provide its functionality, communication system 104 may be implemented with one or more wired and/or wireless networks. Any of these networks may be a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of data processing systems that each host siloed data by using local model instances. Operation of the local instances may be updated based on a set of global model weights obtained by a management system. By doing so, a quality of computer-implemented services provided by the data processing systems based on the siloed data may be improved.

While illustrated in FIG. 1 with a limited number of specific components, a system may include additional, fewer, and/or different components without departing from embodiments disclosed herein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 232) is used to represent data structures, a second set of shapes (e.g., 200, 202, etc.) is used to represent processes performed using and/or that generate data, and a third set of shapes (e.g., 204, 206, etc.) is used to represent large scale data structures such as databases.

Turning to FIG. 2A, a first data flow diagram in accordance with an embodiment is shown. The first data flow diagram may illustrate data used in and data processing performed in obtaining local model instances for data processing systems.

To obtain local model instances of an inference model, global model generation process 200 may be performed. During global model generation process 200, an inference model architecture may be selected, and the selected inference model architecture may be distributed to data processing systems 100. For example, to select the inference model architecture, management system 102 may (i) identify a type of desired inferences (e.g., forecasted information, data classification, etc.), (ii) identify a type and/or quantity of input data for the inference model (e.g., text, values, images, etc.), (iii) assess computational constraints of data processing systems 100, (iv) select a foundation model (e.g., artificial intelligence model, neural network, etc.), (v) define initial parameters for the foundation model, and/or via any other processes.

Once selected, the inference model architecture may be distributed to data processing systems 100. For example, the inference model architecture may be distributed by (i) packaging the inference model architecture in a format (e.g., a serialized file) that may be accessible by data processing systems 100, (ii) obtaining parameters of the inference model architecture (e.g., weights, layers of a neural network, configurations, etc.) that may be used to reproduce the inference model architecture, (iii) transmitting the inference model architecture to each data processing system of data processing systems 100 via a secure communication channel, and/or performing any other actions. By doing so, each data processing system may provision a local model instance.

Local model 204 may include any number and/or type of information regarding local model instances provisioned by data processing systems 100. For example, local model 204 may include a containerized module that hosts software for implementing an inference model, stores data relevant to the inference model (e.g., configuration data, weights, etc.), executes instructions for operation of the inference model, and/or any performs any other actions. Each local model instance may be hosted on a respective data processing system of data processing systems 100 (e.g., on hardware resources of the respective data processing system). Local model 204 may include sets of weights that may initially be defined by the set of weights provided by management system 102 (e.g., the set of weights of the global model).

Siloed data repository 206 may include any number and type of stored data related to operation of data processing systems 100. For example, siloed data repository 206 may include databases that may store data collected by data processing systems 100. Each database may be hosted on a respective data processing system of data processing systems 100 (e.g., on hardware resources of the respective data processing system). The stored data may include, for example, performance data, health data, application data, telemetry data, and/or any other data. Furthermore, the stored data on each database may be restricted from movement from the respective data processing system (e.g., due to administrative regulation, confidentiality, computational limitations, etc.).

To obtain a trained local model, local model training process 208 may be performed. During local model training process 208, weights of local model 204 may be updated based on data hosted by respective data processing systems. For example, to update the weights of a local model 204, each data processing system that hosts a local model instance may (i) ingest a portion of training data from siloed data repository 206, (ii) train the local model instance using the training data to obtain updated weights for the local model instance (e.g., that may fit the training data), (iii) evaluate a quality of the local model instance that uses the updated weights, and/or via any other processes. By doing so, each local model instance hosted by respective data processing systems may include a set of weights based on a portion of siloed data hosted by the respective data processing system.

Trained local model 210 may include any number and/or type of information regarding local model instances hosted by data processing systems 100 and trained using at least a portion of data stored on siloed data repository 206. Trained local model 210 may include different sets of weights compared to local model 204 as a result of local model training process 208. For example, each local model instance of each respective data processing system may be different (e.g., include a different set of weights) due to training using different training data hosted on each respective data processing system.

Thus, using the data flow shown in FIG. 2A, trained local model instances of an inference model may be obtained for each data processing system. By doing so, a set of weights for each trained local model instance may be provided to a management system for use in updating a global model.

Turning to FIG. 2B, a second data flow diagram in accordance with an embodiment is shown. The second data flow diagram may illustrate data used in updating a set of weights for a global model that may update local model instances hosted by data processing systems.

To update a set of weights for the global model, data collection process 220 may be performed. During data collection process 220, new data may be made available to data processing systems 100. For example, to make new data available, data processing systems 100 may (i) monitor operation of data processing systems 100, (ii) collect data using hardware resources (e.g., sensors), (iii) generate logs based on activity of data processing systems 100, (iv) storing the new data on storage hosted by data processing systems 100, and/or performing any other actions. By doing so, the new collected data may be stored in siloed data repository 206 and accessed to update local model instances (and/or provide any other computer-implemented services).

To obtain updated sets of weights for trained local model 210, local model updating process 222 may be performed. During local model updating process, trained local model instances may be retrained using newly available training data to obtain updated local model weights, and the updated local model weights may be provided to management system 102. For example, to retrain the local model instances, data processing systems 100 may: (i) obtain a set of global model weights from management system 102, (ii) ingest a portion of training data from siloed data repository 206 that may include at least a portion of the newly collected data, (ii) train the local model instance using the portion of training data to obtain updated weights for the local model instance (e.g., that may fit the training data), (iii) optimize parameters of the local model instance to obtain a set of weights, and/or perform any other actions. By doing so, updated local model weights may be provided to management system 102.

For example, to provide the updated local model weights to management system 102, data processing systems 100 may: (i) transmit a set of the updated local model weights as a message to management system 102 via a secure communication channel, (ii) compute a set of gradients relative to the updated local model weights and the global model weights, (iii) store the set of updated local model weights in a storage for subsequent retrieval by management system 102, and/or perform any other actions.

To obtain weightage information relevant to data processing systems 100, data processing systems 100 may perform evaluation process 224. During evaluation process 224, a quality of inferencing provided by local model 204 may be identified. For example, to identify the quality of inferencing provided by local model 204, data processing systems 100 may (i) identify an accuracy of inferences provided by local model 2 (e.g., via testing, validation, etc.), (ii) perform a quantification function with respect to desirability of a portion of computer-implemented services provided by data processing systems based on the inferences (e.g., a level of adherence to a service level agreement, key performance metrics, etc.), (iii) identify a volume of training data used to train local model 204, and/or perform any other actions.

Weightage information 226 may include any number and/or type of information regarding a quality of a respective local model instance for a data processing system of data processing systems 100. For example, weightage information 226 may include training data size, local model accuracy rates, data anomaly indicators, and/or any other information. Weightage information 226 may be used by management system 102, for example, to identify a level of contribution of a set of weights provided by a respective data processing system relative to sets of weights provided by other data processing systems that host local model instances.

To obtain an updated set of global model weights, global model updating process 228 may be performed. During global model updating process 228, a set of updated global model weights may be obtained based on sets of model weights and weighted information 226. For example, to obtain the set of updated global model weights, management system 102 may (i) compute a proportion of training data used by respective data processing systems to a total quantity of training data, (ii) identify a level of anomalousness of a proportion of training data used by respective data processing systems, (iii) perform a weighted aggregation based the sets of model weights and weighted information 226 to obtain the set of updated global model weights, (iv) update a global model hosted by management system 102 based on the set of updated global model weights, (v) distribute the set of updated global model weights to data processing systems 100, and/or perform any other actions.

Thus, using the data flow shown in FIG. 2B, a management system may obtain a set of updated global model weights based on sets of local model weights obtained from the data processing systems and weightage information for the data processing systems. By doing so, operation of local model instances hosted by the data processing systems may be updated using the set of updated global model weights.

Turning to FIG. 2C, a third data flow diagram in accordance with an embodiment is shown. The third data flow diagram may illustrate data used in and data processing performed in providing computer-implemented services using the local model instances.

To use the local model instances, inferencing process 230 may be performed. During inferencing process 230, an inference result may be obtained based on siloed data and a local model instance. For example, to obtain the inference result, data processing system: (i) ingest at least a portion of data from siloed data repository 206 into local model 204, (ii) initialize operation of local model 204 using global model weights obtained from management system 102, and/or perform any other actions. By doing so, data processing systems 100 may obtain inference 232.

Inference 232 may include any number and/or type of information regarding a result of inferencing process 230. For example, inference 232 may include forecasted values based on at least a portion of data from siloed data repository 206, classifications for the portion of data, enhanced insights regarding the portion of data, and/or any other information. Inference 232 may include different inferences for each data processing system of data processing systems 100 based on siloed data hosted by the respective data processing system.

To provide computer-implemented services, service providing process 234 may be performed. During service providing process 234, operation of data processing systems 100 may be updated. For example, to update operation of data processing systems 100, (i) inference 232 may be analyzed to identify an action set to perform, (ii) operation of hardware and/or software resources hosted by data processing systems 100 may be modified based on the action set, (iii) enhanced information usable to make a management decision may be obtained, and/or any other processes may be performed.

Thus, using the data flow shown in FIG. 2C, data processing systems may obtain inferences using local model instances based on a set of global model weights and siloed data hosted on respective data processing systems. By doing so, a quality of computer-implemented services provided by the data processing systems using the inferences may be improved.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage data processing systems. FIGS. 3A-3C illustrate methods that may be performed by the components of the system of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a flow diagram illustrating a method of managing operation of data processing systems that each host siloed data that is restricted from movement between the data processing systems in accordance with an embodiment is shown. The method may be performed, for example, by any of the components of the system of FIG. 1, and/or other components not shown therein.

Prior to operation 300, local model instances of an inference model may be established on the data processing systems. The local model instances may be established by: (i) selecting, by a management system, an inference model architecture, (ii) distributing at least a portion of the inference model architecture to the data processing systems, and/or via any other processes. Refer to FIG. 3B for additional details regarding establishing the local model instances.

At operation 300, a set of model weights and weightage information may be obtained from each data processing system. The set of model weights and weightage information may be obtained by: (i) training the local model instances using at least a portion of respective siloed data hosted by the respective data processing system to obtain sets of weights, (ii) evaluating an accuracy of the local model instances that use the set of weights, (iii) quantifying a level of adherence of a portion of computer-implemented services provided based on use of the local model instances to a service level agreement, (iv) transmitting the set of model weights and information via a secure communication channel, and/or via any other processes.

At operation 302, a set of global model weights may be obtained using the sets of model weights and weightage information. The set of global model weights may be obtained by: (i) performing a weighted aggregation using the sets of weights and weighted information to obtain a set of global model weights that may be based on levels of contribution by the data processing systems, (ii) computing second weighted information based on the first weighted information (e.g., to identify a proportion of training data hosted by a data processing system to a total quantity of training data available to all data processing systems, to identify a level of anomalousness of the portion of training data, etc.), and/or performing any other actions.

At operation 304, operation of the local model instances hosted by the data processing systems may be updated using the set of global model weights. The operation of the local model instances may be updated by: (i) transmitting the set of global model weights to each data processing system, (ii) instructing the data processing systems to use the set of global model weights when operating the local model instances, (iii) generating inferences using the updated local model instances (e.g., that use the set of global model weights) based on siloed data hosted on the respective data processing systems, (iv) updating operation of the data processing systems based on the inferences, and/or performing any other actions.

The method may end following operation 304.

Using the method shown in FIG. 3A, operation of data processing systems may be managed using local model instances based on a set of global model weights. The global model weights may provide a generalized inference model that may improve a quality of computer-implemented services provided by the data processing systems using siloed data hosted on the respective data processing system.

Turning to FIG. 3B, a second flow diagram illustrating a method of establishing local model instances for each data processing system of the data processing systems in accordance with an embodiment is shown. The method may be performed, for example, by any of the components of the system of FIG. 1, and/or other components not shown therein.

At operation 310, a model architecture may be selected. The model architecture may be selected by: (i) identifying a type and/or quantity of siloed data hosted by the data processing systems, (ii) identifying a type of desired inferences (e.g., forecasted information, data classification, etc.), (iii) selecting a foundation model framework (e.g., TensorFlow, PyTorch, etc.), (iv) defining initial parameters for the foundation model framework, and/or performing any other processes.

At operation 312, the model architecture may be distributed to the data processing systems to facilitate obtaining of the local model instances. The model architecture may be distributed by: (i) packaging the model architecture in a format (e.g., a serialized file) that may be accessible by data processing systems 100, (ii) obtaining parameters of the model architecture (e.g., weights, layers of a neural network, configurations, etc.) that may be used to reproduce the inference model architecture, (iii) transmitting the model architecture to each data processing system of data processing systems 100 via a secure communication channel, and/or performing any other actions.

The method may end following operation 312.

Using the method shown in FIG. 3B, local model instances may be established on data processing systems that may be trained locally using siloed data hosted on a respective data processing system. By doing so, each data processing system may obtain a set of weights for the respective local model instance that may be usable to update a global model managed by the data processing system.

Turning to FIG. 3C, a third flow diagram illustrating a method of iteratively updating a set of global model weights in accordance with an embodiment is shown. The method may be performed, for example, by any of the components of the system of FIG. 1, and/or other components not shown therein.

At operation 320, the updated local models may be iteratively retrained by respective data processing systems as new training data becomes available. The updated local models may be iteratively retrained by: (i) collecting new data relevant to operation of the data processing systems, (ii) storing the new data on respective siloed data storage hosted by the respective data processing system, (iii) selecting a portion of training data that may include at least a portion of the new data, (iv) training each local model instance using the set of global model weights obtained from the management system and the training data to obtain updated sets of weights, and/or performing any other actions.

At operation 322, the set of global model weights may be updated during the iterative retraining. The set of global model weights may be updated by: (i) obtaining the updated sets of weights from each data processing system via transmission using a secure communication channel, (ii) obtaining weightage information from the data processing systems, (iii) performing a weighted aggregation to obtain a set of updated global model weights, and/or performing any other processes.

The method may end following operation 322.

Using the method shown in FIG. 3C, local model instances may be updated by retraining each local model instance as new data becomes available on the respective data processing systems. By doing so, a quality of computer-implemented services (e.g., a predictive capability) provided using the local model instances may be improved.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS® /iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing operation of data processing systems that each host siloed data that is restricted from movement between the data processing systems, the method comprising:
obtaining, from each of the data processing systems:
a set of model weights from a local model instance of an inference model that is hosted by a respective data processing system and that was trained using at least a portion of the respective siloed data hosted by the respective data processing system, and
weightage information for the respective data processing system;
obtaining a set of global model weights using the sets of model weights and weightage information; and
updating operation of the local model instances hosted by the data processing systems using the set of global model weights to initiate provisioning of computer-implemented services by the data processing systems using the updated local model instances.

2. The method of claim 1, wherein the weightage information indicates a quality of inferences provided by the local model instance with respect to a portion of the computer-implemented services provided by the respective data processing system.

3. The method of claim 2, wherein the quality is based on a quantification function with respect to the computer-implemented services, the quantification function providing a quantification regarding desirability of the portion of the computer-implemented services.

4. The method of claim 3, wherein the desirability of the portion of the computer-implemented services is based on a level of adherence of the portion of the computer-implemented services to a service level agreement for the portion of the computer-implemented services.

5. The method of claim 1, wherein the weightage information indicates an accuracy of inferences provided by the local model instance.

6. The method of claim 1, wherein the weightage information is based on a proportion of training data hosted by the respective data processing system to a total quantity of training data available to train all of the local model instances hosted by all of the data processing systems.

7. The method of claim 1, wherein the weightage information is based on a level of anomalousness of a proportion of training data hosted by the respective data processing system with respect to all training data available to train all of the local model instances hosted by all of the data processing systems.

8. The method of claim 1, further comprising:
prior to obtaining the set of model weights:
selecting a model architecture; and
distributing the model architecture to the data processing systems to facilitate obtaining of the local model instances through local training by each of the data processing systems.

9. The method of claim 8, further comprising:
after updating the operation of the local model instances:
iteratively retraining the updated local model instances by the respective data processing systems that host the updated local model instances as new training data becomes available to the respective data processing systems; and
updating the set of weights during the iterative retraining based on new sets of model weights obtained by the respective data processing systems.

10. The method of claim 1, wherein siloed data comprises at least one selected from a list of types of information consisting of:
first information subject to administrative regulation that restricts movement of the first information between the data processing systems;
second information subject to confidentiality that restricts movement of the second information between the data processing systems; and
third information subject to computational resource limitations that restricts movement of the third information between the data processing systems.

11. A non-transitory machine-readable medium having instructions stored therein, which when executed by a processor, cause the processor to perform operations for managing operation of data processing systems that each host siloed data that is restricted from movement between the data processing systems, the operations comprising:
obtaining, from each of the data processing systems:
a set of model weights from a local model instance of an inference model that is hosted by a respective data processing system and that was trained using at least a portion of the respective siloed data hosted by the respective data processing system, and
weightage information for the respective data processing system;
obtaining a set of global model weights using the sets of model weights and weightage information; and
updating operation of the local model instances hosted by the data processing systems using the set of global model weights to initiate provisioning of computer-implemented services by the data processing systems using the updated local model instances.

12. The non-transitory machine-readable medium of claim 11, wherein the weightage information indicates a quality of inferences provided by the local model instance with respect to a portion of the computer-implemented services provided by the respective data processing system.

13. The non-transitory machine-readable medium of claim 12, wherein the quality is based on a quantification function with respect to the computer-implemented services, the quantification function providing a quantification regarding desirability of the portion of the computer-implemented services.

14. The non-transitory machine-readable medium of claim 13, wherein the desirability of the portion of the computer-implemented services is based on a level of adherence of the portion of the computer-implemented services to a service level agreement for the portion of the computer-implemented services.

15. The non-transitory machine-readable medium of claim 11, wherein the weightage information indicates an accuracy of inferences provided by the local model instance.

16. A data processing system, comprising:
a processor; and
a memory coupled to the processor to store instructions, which when executed by the processor, cause the processor to perform operations for managing operation of data processing systems that each host siloed data that is restricted from movement between the data processing systems, the operations comprising:
obtaining, from each of the data processing systems:
a set of model weights from a local model instance of an inference model that is hosted by a respective data processing system and that was trained using at least a portion of the respective siloed data hosted by the respective data processing system, and
weightage information for the respective data processing system;
obtaining a set of global model weights using the sets of model weights and weightage information; and
updating operation of the local model instances hosted by the data processing systems using the set of global model weights to initiate provisioning of computer-implemented services by the data processing systems using the updated local model instances.

17. The data processing system of claim 16, wherein the weightage information indicates a quality of inferences provided by the local model instance with respect to a portion of the computer-implemented services provided by the respective data processing system.

18. The data processing system of claim 17, wherein the quality is based on a quantification function with respect to the computer-implemented services, the quantification function providing a quantification regarding desirability of the portion of the computer-implemented services.

19. The data processing system of claim 18, wherein the desirability of the portion of the computer-implemented services is based on a level of adherence of the portion of the computer-implemented services to a service level agreement for the portion of the computer-implemented services.

20. The data processing system of claim 18, wherein weightage information indicates an accuracy of inferences provided by the local model instance.
